(19) United States
(12) Patent Application Publication
(10) Pub. No.: US 2011/0286117 A1
(43) Pub. Date: Nov. 24, 2011

(54) Camera lens for industrial camera

(76) Inventor: Wen-Chien Wang, Shulin City (TW)

(21) Appl. No.: 12/781,865

(22) Filed: May 18, 2010

(51) Int. Cl. G02B 7/02

(52) U.S. Cl. 359/808

(57) ABSTRACT

A camera lens for use in an industrial camera for enabling the industrial camera to calculate the length and height of an object focused by the industrial camera and the distance between the focused object and the industrial camera is disclosed to include a cylindrical lens holder, and a lens, which is fixedly mounted in a mounting portion inside the cylindrical lens holder, having a reference point located on the inner surface thereof at the center and a positioning frame extending from the reference point to the outer surface thereof at an angle about 45°.

### BACKGROUND OF THE INVENTION

1. Field of the Invention

The present invention relates to camera lens design technology and more particularly, to a camera lens for use in an industrial camera for enabling the industrial camera to calculate the length and height of an object focused by the industrial camera and the distance between the focused object and the industrial camera.

2. Description of the Related Art

When measuring the area of an object, a measuring tape is usually used to measure the length and height of the object and then measured length and height values are calculated to obtain the area value of the object. This measuring method is complicated, wasting much time and labor. When measuring the size of a big object, one person may be unable to complete the measurement by oneself. In this case, an assistant is necessary.

Therefore, it is desirable to provide a measure that facilitates measurement of the area of an object by means of a camera.

### SUMMARY OF THE INVENTION

The present invention has been accomplished under the circumstances in view. It is the main object of the present invention to provide a camera lens for industrial camera, which matches the auto focus sensor of the industrial camera, for enabling the software in the microchip of the industrial camera to calculate the length and height of the focused object accurately and rapidly, saving much measuring labor and time.

To achieve this and other objects of the present invention, a camera lens comprises cylindrical lens holder, and a lens fixedly mounted in a mounting portion inside the cylindrical lens holder. The lens has a reference point located on the inner surface thereof at the center, and a positioning frame extending from the reference point to the outer surface thereof at an angle about 45°.

Further, the lens holder comprises a mounting structure for mounting on a lens mount of an industrial camera. The mounting structure comprises two spring members bilaterally symmetrically disposed in the rear side of the lens holder, and two retaining rods respectively supported on the spring members and facing each other and adapted for securing the camera lens to a lens mount of an industrial camera.

### BRIEF DESCRIPTION OF THE DRAWINGS

FIG. 1 is a sectional view of a camera lens for industrial camera in accordance with a first embodiment of the present invention.

FIG. 2 is a sectional elevation of the camera lens for industrial camera in accordance with the first embodiment of the present invention.

FIG. 3 is a schematic drawing showing the area in the lens divided into multiple equal blocks for measurement.

FIG. 4 is a sectional view of a camera lens for industrial camera in accordance with a second embodiment of the present invention.

FIG. 5 illustrates a status of use of the camera lens in accordance with the second embodiment of the present invention.

### DETAILED DESCRIPTION OF THE PREFERRED EMBODIMENT

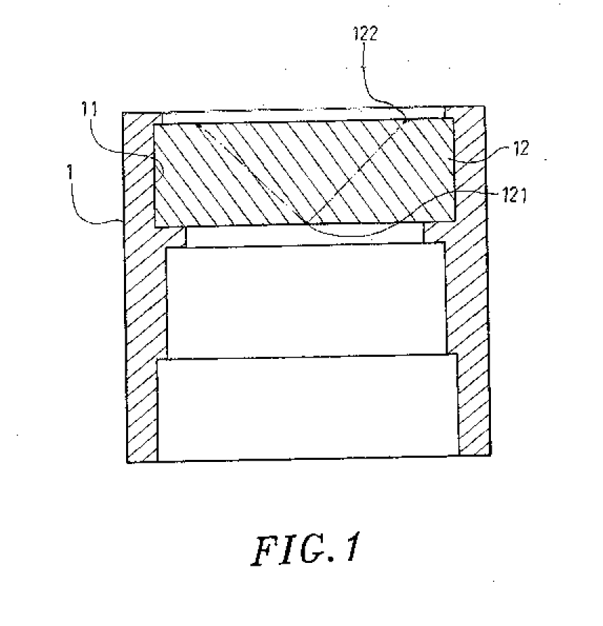

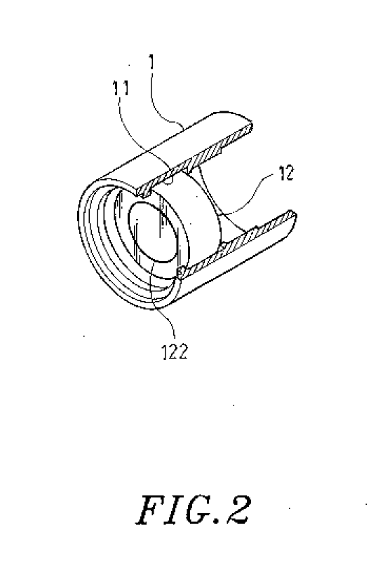

Referring to FIGS. 1 and 2, a camera lens for industrial camera in accordance with a first embodiment of the present invention is shown comprising a cylindrical lens holder 1 and a lens 12 mounted in the cylindrical lens holder 1. The cylindrical lens holder 1 defines therein a mounting portion 11. The lens 12 is fixedly mounted in the mounting portion 11 inside the cylindrical lens holder 1, having a reference point 121 located on the inner surface thereof at the center and a positioning frame line 122 located on the outer surface thereof. The positioning frame line 122 extends from the reference point 121 at a predetermined angle, for example, 45°. Further, the positioning frame line 122 can be shaped like a cone or quadrilateral pyramid. According to this embodiment, the positioning frame line 122 is made in the shape of a cone.

After installation of the lens 12 in the mounting portion 11 inside the cylindrical lens holder 1, the camera lens can then be mounted in an industrial camera. When in use, the industrial camera is aimed at the object to be measured so that the image of the object is displayed on the screen of the industrial camera. At this time, the auto-focusing sensor module of the industrial camera senses the configuration of the object subject to the indication of the reference point 121 and the positioning frame line 122, for enabling the software in the microchip of the industrial camera to calculate the length and height of the object and to further obtain the area of the object rapidly arid precisely.

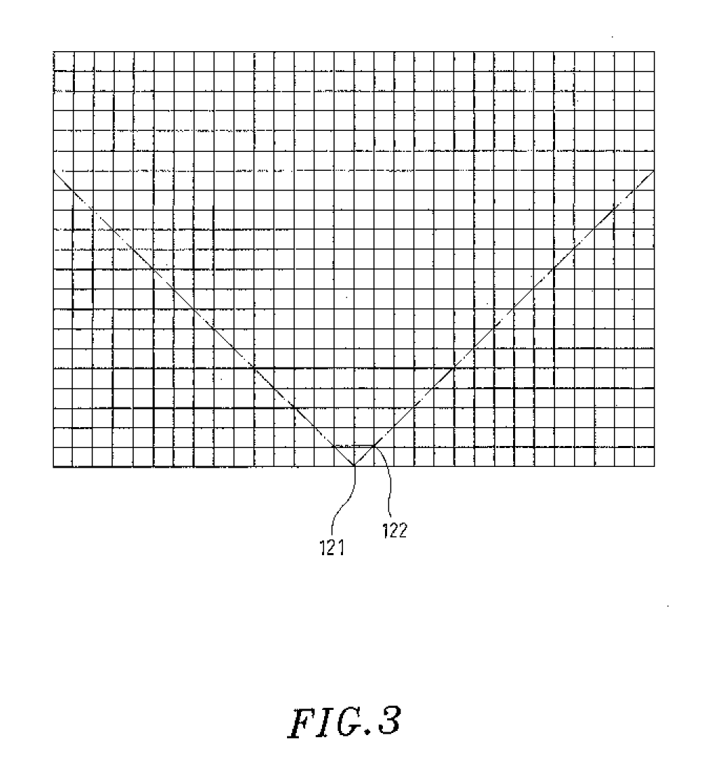

Referring to FIG. 3, the lens 12 provides a reference point 121 at the center of the inner surface thereof and a positioning frame line 122 located on the outer surface thereof and extending from the reference point 121 at an angle about 45°. The area in the lens 12 that extends from the reference point 121 to the positioning frame line 122 at art angle about 45° is divided into multiple equal blocks. Thus, the length and height of an object of which the image is appeared in any position in the positioning frame line 122 can be calculated by a software in the microchip of the camera using the camera lens of the present invention subject to the operation of the camera to focus on the object and the number of blocks occupied by the image of the object. Subject to the length and height of the object calculated, the distance between the object and the camera can then be calculated by the software.

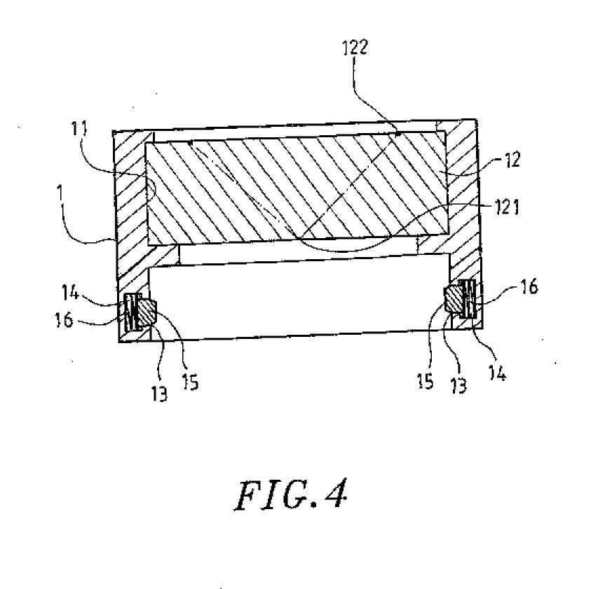

FIG. 4 is a sectional view of a camera lens in accordance with a second embodiment of the present invention. According to this second embodiment, the camera lens comprises a cylindrical lens holder 1 and a lens 12 mounted in the cylindrical lens holder 1. The cylindrical lens holder 1 defines therein a mounting portion 11. The lens 12 is fixedly mounted in the mounting portion 11 inside the cylindrical lens holder 1, having a reference point 121 located on the inner surface thereof at the center and a positioning frame line 122 located on the outer surface thereof. The positioning frame line 122 extends from the reference point 121 at a predetermined angle, for example, 45°. According to this second embodiment, the cylindrical lens holder 1 further comprises a mounting structure bilaterally symmetrically disposed in the rear side thereof for fastening camera lens to a front lens mount of a camera. The mounting structure comprises two transverse holes 13 bilaterally disposed in the rear side inside the lens holder 1 and aimed at each other, two recessed portions 14 respectively located on the inner side of each of the transverse holes 13, two spring members 16 respectively mounted in the recessed portions 14, and two retaining rods 15 respectively supported on the spring members 16 and movable in and out of the transverse holes 13.

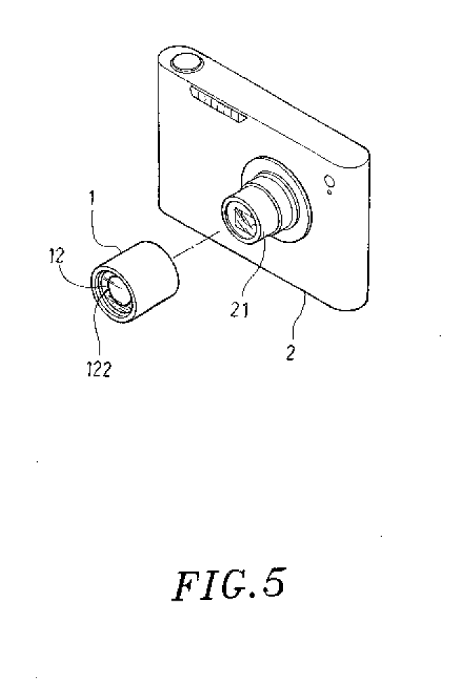

Referring to FIG. 5 and FIG. 4 again, the lens holder 1 of the camera lens can be attached to the lens mount 21 of a camera 2. After attachment of the lens holder 1 of the camera lens to the lens mount 21 of the camera 2, the retaining rods 1 are forced by the spring members 16 to stop against the periphery of the lens mount 21, securing the camera lens to the lens mount 21 of the camera 2 positively. By means of the reference point 121 and the positioning frame line 122, the length and height of the object focused by the camera 2 and the distance between the object and the camera 2 can be calculated accurately by the software in the micro chip in the camera 2.

Although particular embodiments of the invention have been described in detail for purposes of illustration, various modifications and enhancements may be made without departing from the spirit and scope of the invention.

What the invention claimed is:

1. A camera lens for use in an industrial camera, comprising:
a cylindrical lens holder, said cylindrical lens holder defining therein a mounting portion; and
a lens fixedly mounted in said mounting portion inside said cylindrical lens holder, said lens having opposing inner surface and outer surface, a reference point located on said inner surface thereof at the center and a positioning frame extending from said reference point to said outer surface at an angle about 45°.

2. The camera lens as claimed in claim 1, wherein said positioning frame line has the shape of a cone.

3. The camera lens as claimed in claim 1, wherein said positioning frame line has the shape of a quadrilateral pyramid.

4. The camera lens as claimed in claim 1, wherein said lens holder comprises a mounting structure bilaterally symmetrically disposed in a rear side thereof for mounting on a lens mount of an industrial camera.

5. The camera lens as claimed in claim 1, wherein said mounting structure of said lens holder comprises two transverse holes bilaterally disposed in the rear side of said lens holder and aimed at each other, two recessed portions respectively located on an inner side of each of said transverse holes, two spring members respectively mounted in said recessed portions, and two retaining rods respectively supported on said spring members and movable in and out of said transverse holes.
